(19) United States
(12) Patent Application Publication
(10) Pub. No.: US 2009/0130523 A1
(43) Pub. Date: May 21, 2009

(54) Tubular Solid Polymer Fuel Cell Comprising a Rod-Shaped Current Collector With Peripheral Glas Flow Channels and Production Method Thereof

(76) Inventors: Toru Sugiyama, Aichi (JP); Yuichiro Hama, Aichi (JP); Sreekumar Kurungot, Aichi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/991,532

(22) PCT Filed: Sep. 7, 2006
(86) PCT No.: PCT/JP2006/318307

§ 371 Date: Mar. 6, 2008

(30) Foreign Application Priority Data
Sep. 7, 2005 (JP) 2005-259180
Jul. 5, 2006 (JP) 2006-185668

(51) Int. Cl. H01M 8/02; H01M 8/10

(52) U.S. Cl. 429/31; 29/623.1

(57) ABSTRACT

There is provided a tubular fuel cell in which a catalyst ink does not penetrate into a gas flow channel at the time of preparing a catalyst layer, and hence does not block the flow channel and thereby improves the electric power generation performance as well as the gals flow property, and there is also provided a production method of the tubular fuel cell. A tubular solid polymer fuel cell including a fuel gas flow channel 2, on the periphery of a rod-shaped current collector 1, communicatively continuous in the axial direction of the rod-shaped current collector, further including a membrane-electrode assembly (MEA) 6 outside the rod-shaped current collector 1 and the fuel gas flow channel 2, and having a structure in which fuel gas flows in the fuel gas flow channel 2 and an oxidizing gas flows outside the membrane-electrode assembly (MEA) 6, the tubular solid polymer fuel cell being characterized in that a part or the whole of the fuel gas flow channel 2 is filled with a porous material having continuous holes communicatively continuous in the axial direction of the fuel gas flow channel.

### TECHNICAL FIELD

The present invention relates to a tubular solid polymer fuel cell using a rod-shaped current collector and a production method of the tubular solid polymer fuel cell.

### BACKGROUND ART

A fuel cell is a device which converts the chemical energy of a fuel directly into electrical energy by electrochemically oxidizing in the cell the fuel such as hydrogen or methanol and takes out the electrical energy. In these years, fuel cells have been attracting attention as clean electrical energy supply sources. In particular, solid polymer fuel cells using a proton exchange membrane as an electrolyte permit obtaining high output power density and operating at low temperatures, and hence are expected to be promising as small size batteries such as electric automobile power supplies, household stationary power supplies, portable device power supplies and transportable power supplies.

Previous solid polymer fuel cells each are constructed by disposing a catalyst layer to be a fuel electrode and another catalyst layer to be an air electrode (an oxygen electrode) respectively on both sides of an electrolyte (a planar plate or a planar membrane), and by further sandwiching the electrolyte having the electrodes with a separator material made of carbon or a separator material made of a metal each having thereon a fuel gas flow channel or an air (oxygen gas) flow channel to form a unit referred to as a unit cell. A separator is interposed between adjacent cells; when cells are stacked, the separators serve to prevent mixing of hydrogen entering the fuel electrode with air entering the air electrode and also serve as electronic conductors to serially connect the adjacent two cells. By stacking as many such unit cells as required, a fuel cell stack is assembled; the stack is further integrated with devices to feed respectively a fuel gas and an oxidizing gas, with a control device and with the like, and consequently a fuel cell is formed to generate electric power.

Such a planar fuel cell configuration is suitable for a design to stack a number of large area electrodes (fuel electrodes and air electrodes), but is low in the degree of freedom for external appearance and shape involving demand for down sizing. Recently, there has been proposed a design in which exclusively planar unit cells are disposed in parallel with each other; such a design sometimes has a merit of easy production of small size chips depending on the shapes of small size devices into which the cells are incorporated, but can hardly attain flexible response to the shapes of various small size devices. In particular, there has been left a problem such that the fuel electrode is to be designed so as to attain effective fuel flow and to develop a countermeasure to prevent fuel leakage.

Accordingly, for the purpose of providing a high output fuel cell that is easily adaptable to downsizing, maintains the gas tightness in the fuel electrode, can resist high pressure difference, and has flexibility as well as mechanical strength, JP Patent Publication (Kokai) No. 2003-297372A has disclosed a fuel cell in which a polymer electrolyte membrane, used to be stacked as planar members, is formed in a tubular shape (hollow) to be used, and the inner surface (wall surface) and/or the outer surface (wall surface) of the tube is provided with carbon fibers supporting a catalyst, and thus the inner and outer surfaces serve as the fuel electrode and the air electrode, respectively.

Alternatively, for the purpose of simplifying the configuration of a unit cell in order to facilitate downsizing and cost reduction, JP Patent Publication (Kokai) No. 2002-124273A has disclosed a solid polymer fuel cell that includes a hollow gas diffusion electrode layer of 0.5 to 10 mm in inside diameter, a polymer solid electrolyte membrane layer formed to surround the periphery of the gas diffusion electrode layer, and another gas diffusion electrode layer formed to surround the periphery of the polymer solid electrolyte membrane layer.

Further, conventional techniques include a method in which a MEA is formed by filling a resin such as PVA in the gas flow channel, namely, the slits, the holes or the like formed in an internal current collector, and then the resin is washed out with a liquid such as water to produce a tubular solid polymer fuel cell. However, this method has the following drawbacks:

(1) This method needs a step for removing the filled resin, and consequently, the production steps become complicated.

(2) As a matter related to the inside of a tubular solid polymer fuel cell, it is difficult to identify whether or not the filled resin has been completely removed, unless the fuel cell is cut or broken.

### DISCLOSURE OF THE INVENTION

### Problems to Be Solved by the Invention

Although conventional tubular fuel cells attain certain advantageous effects from the viewpoint of downsizing, there are some problems involving the internal gas flow property, and the conventional tubular fuel cells are thereby limited in their electric power generation performance.

Accordingly, the present invention provides a tubular fuel cell in which a catalyst ink does not penetrate into a gas flow channel at the time of preparing a catalyst layer, and hence does not block the flow channel and improves the gas flow property and thereby improves the electric power generation performance, and the present invention also provides a production method of the tubular fuel cell.

### Means for Solving the Problems

The present inventors have achieved the present invention by discovering that the above described problems can be solved by filling a specific material in a part or the whole of the fuel gas flow channel of a rod-shaped current collector having a specific structure.

More specifically, a first aspect of the present invention is a tubular solid polymer fuel cell including a fuel gas flow channel, on the periphery of a rod-shaped current collector, communicatively continuous in the axial direction of the rod-shaped current collector, further including a membrane-electrode assembly (MEA) outside the rod-shaped current collector and the fuel gas flow channel, and having a structure in which fuel gas flows in the fuel gas flow channel and an oxidizing gas flows outside the membrane-electrode assembly (MEA), the tubular solid polymer fuel cell being characterized in that a part or the whole of the fuel gas flow channel is filled with a porous material having continuous holes communicatively continuous in the axial direction of the fuel gas flow channel. In the tubular solid polymer fuel cell of the present invention, the fuel gas smoothly passes through the porous material filled in a part or the whole of the fuel gas flow channel, and thereby improves, in cooperation with the oxidizing gas flowing outside the membrane-electrode assembly (MEA), the electric power generation performance in the membrane-electrode assembly (MEA).

In the present invention, the shape of the fuel gas flow channel is preferably such that the fuel gas flow channel includes one or more slits disposed on the periphery of the rod-shaped current collector so as to be communicatively continuous in the axial direction of the rod-shaped current collector.

In the present invention, the porous material is preferably imparted with a gradient structure in which the pore size is increased from the periphery of the rod-shaped current collector toward an internal current collector because such a gradient structure improves the gas diffusivity and water drainage.

As the porous material that constitutes the most prominent feature of the tubular solid polymer fuel cell of the present invention, there may be applied various materials such as ceramic materials made of inorganic materials, compression molded articles of inorganic fibers, compression molded articles of carbon fibers, molded articles composed of inorganic materials and organic binders, molded articles composed of carbon fibers and organic binders, mica, porous sintered compacts composed of inorganic materials, and nonwoven fabrics composed of inorganic fibers. Examples of such materials include alumina and silica, and particularly preferred among them is γ-alumina.

The pore size of the pores in the porous material is set in relation to the particle size of the catalyst fine particles in the catalyst layer in contact with the porous material. It is taken into account that while a catalyst ink is being coated, catalyst fine particles may not penetrate into the pores of the porous material to block the pores. Therefore, the pore size of the pores in the porous material is preferably 1 nm to 100 nm and more preferably 10 nm to 40 nm. The porosity of the porous material is preferably 40 to 90% and more preferably 70 to 90%.

For the purpose of imparting electrical conductivity to the porous material and reducing the cell resistance at the time of the electric power generation of the fuel cell, fine particles having corrosion resistance and electrical conductivity are preferably mixed in the porous material. Examples of the fine particles having corrosion resistance and electrical conductivity may preferably include fine particles formed of carbon black, gold or platinum.

For the rod-shaped current collector disposed in the central portion of the tubular solid polymer fuel cell of the present invention, various electrically conductive materials are used. Examples of such materials include metal materials or carbon materials. Most preferred among these is gold.

A second aspect of the present invention is a production method of the tubular solid polymer fuel cell, which method includes steps of: forming a fuel gas flow channel on the periphery of a rod-shaped current collector, communicatively continuous in the axial direction of the rod-shaped current collector; filling a part or the whole of the fuel gas flow channel of the rod-shaped current collector including the fuel gas flow channel with a porous material having continuous holes communicatively continuous in the axial direction of the fuel gas flow channel; and fabricating a membrane-electrode assembly (MEA) outside the rod-shaped current collector and the fuel gas flow channel.

In the production method of a tubular solid polymer fuel cell of the present invention, as described above are the following: the shape of the fuel gas flow channel, the imparting of a structure gradient in pore size to the porous material, the type of the porous material, the pore size of the pores in the porous material, the porosity of the porous material, the mixing of the fine particles having corrosion resistance and electrical conductivity in the porous material, the material of the rod-shaped current collector and the like.

In the present invention, when the porous material is γ-alumina, the step for filling the porous material preferably includes the coating of a γ-alumina paste onto the fuel gas flow channel or the filling of a γ-alumina paste in the fuel gas flow channel and the subsequent firing.

Additionally, the secondary particle size of the particles in the catalyst paste to be used in the step for fabricating the membrane-electrode assembly (MEA) is preferably 100 nm or more, because such particles do not penetrate into the pores in the porous material.

A third aspect of the present invention relates to applications of the above described tubular solid polymer fuel cell, and is characterized in that the tubular solid polymer fuel cell is used as electric power supplies for portable devices. The fuel cell of the present invention is easily adaptable to downsizing, high in output power density, expected to be promising in long term durability, and easy to handle, and hence can be utilized as power supplies for portable electric/electronic devices such as telephone sets, video cameras and lap top personal computers, and as power supplies for transportable electric/electronic devices.

### ADVANTAGES OF THE INVENTION

The present invention includes a fuel gas flow channel, on the periphery of a rod-shaped current collector, communicatively continuous in the axial direction of the rod-shaped current collector, and a porous material, having continuous holes communicatively continuous in the axial direction of the fuel gas flow channel, filled in a part or the whole of the fuel gas flow channel; hence, the fuel gas smoothly passes through the porous material filled in a part or the whole of the fuel gas flow channel. Consequently, the smoothly passing fuel gas thereby improves, in cooperation with the oxidizing gas flowing outside the membrane-electrode assembly (MEA), the electric power generation performance in the membrane-electrode assembly (MEA). Additionally, the porous material, having continuous holes communicatively continuous in the axial direction of the fuel gas flow channel, is filled in a part or the whole of the fuel gas flow channel, and hence a catalyst ink does not penetrate into the gas flow channel at the time of preparing a catalyst layer, and does not block the flow channel; thus, the electric power generation performance as well as the gas flow property is improved.

In particular, when the porous material is imparted with a gradient structure in which the pore size is increased from the periphery of the rod-shaped current collector toward the internal current collector, such a gradient structure improves the gas diffusivity and water drainage, and hence further improves the electric power generation performance.

Further, the tubular solid polymer fuel cell of the present invention has a tubular shape in the center of which a rod-shaped current collector is located, and hence is not only adaptable to downsizing, but is adaptable to the provision of batteries that meet various levels of output power by appropriately designing the lengths and diameters of the rod-shaped current collector and the tube, and also by appropriately connecting units each including such a tube. The part composed of the porous material filled in the rod-shaped current collector is excellent in gas tightness, and hence is particularly suitable for forming the fuel electrode. Additionally, the tubular solid polymer fuel cell of the present invention is not only excellent in shape flexibility but can maintain the strength, and hence can solve the problem of the stacking material to be controversial in the design of fuel cells.

### BRIEF DESCRIPTION OF THE DRAWINGS

FIG. 1 shows a schematic view of a tubular solid polymer fuel cell of the present invention;

FIGS. 2A-2C show schematic sectional views illustrating an outline of the production steps of the tubular solid polymer fuel cell of the present invention;

FIG. 3 shows schematic sectional views illustrating an outline of the production steps of the tubular solid polymer fuel cell of the present invention in which fuel cell a porous material is imparted with a gradient structure in which the pore size is increased from the periphery of a rod-shaped current collector toward an internal current collector;

FIG. 4 shows schematic sectional views illustrating a case where a catalyst paste is coated directly onto the internal current collector in the tubular fuel cell;

FIG. 5 shows schematic sectional views illustrating a case where a resin such as polyvinyl alcohol (PVA) is beforehand filled in a gas flow channel;

FIG. 6 shows schematic sectional views illustrating a case where γ-alumina is filled in slits as the gas flow channel of the internal current collector in the tubular fuel cell;

FIG. 7 shows the pressure loss of a gas inside each of the MEA cells of Examples 1 and 2; and

FIG. 8 shows the electric power generation performance (I-V curve) for each of the MEAs of Examples 1 and 2.

### DESCRIPTION OF SYMBOLS

1: Rod-shaped current collector, 2: Fuel gas flow channel, 3: Electrode catalyst layer, 4: Polymer electrolyte membrane, 5: Electrode catalyst layer, 6: Membrane-electrode assembly (MEA)

### BEST MODE FOR CARRYING OUT THE INVENTION

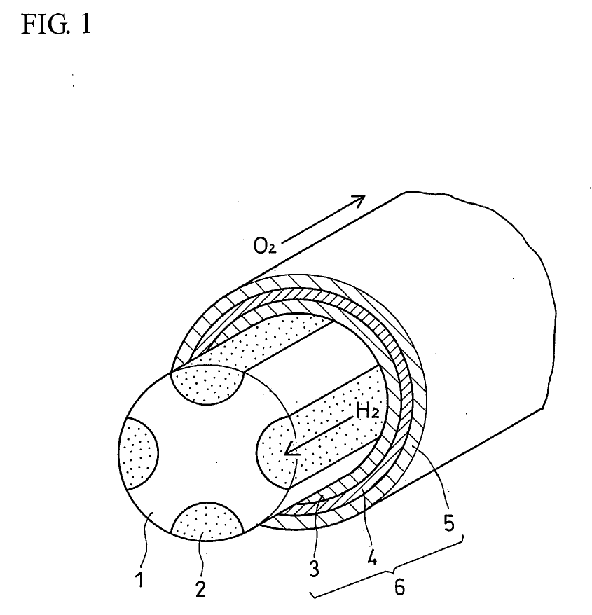

FIG. 1 shows a schematic view of a tubular solid polymer fuel cell of the present invention. There are disposed four slits, to form a fuel gas flow channel 2 communicatively continuous in the axial direction of a rod-shaped current collector 1, on the periphery of the rod-shaped current collector 1. Further, outside the rod-shaped current collector 1 and the fuel gas flow channel 2, there is disposed, in a tubular form, a membrane-electrode assembly (MEA) 6 formed of an electrode catalyst layer 3, a polymer electrolyte membrane 4 and another electrode catalyst layer 5. Although not shown in the figure, another current collector is disposed outside the membrane-electrode assembly (MEA) 6. In the fuel gas flow channel 2, there is filled a porous material having continuous holes communicatively continuous in the axial direction of the fuel gas flow channel 2. A fuel gas (H₂) flows in the fuel gas flow channel 2, and an oxidizing gas (air or O₂) flows outside the membrane-electrode assembly (MEA) 6. In practical applications, unit fuel cells as described above are connected to each other in parallel and/or serially to form a stack.

In FIG. 1 the porous material is filled in the whole of the fuel gas flow channel 2, but may be filled in a part of the fuel gas flow channel 2. Also in FIG. 1, the fuel gas flow channel 2 includes four slits disposed on the periphery of the rod-shaped current collector 1 so as to be communicatively continuous in the axial direction of the rod-shaped current collector 1, but no constraint is imposed on the number of such slits.

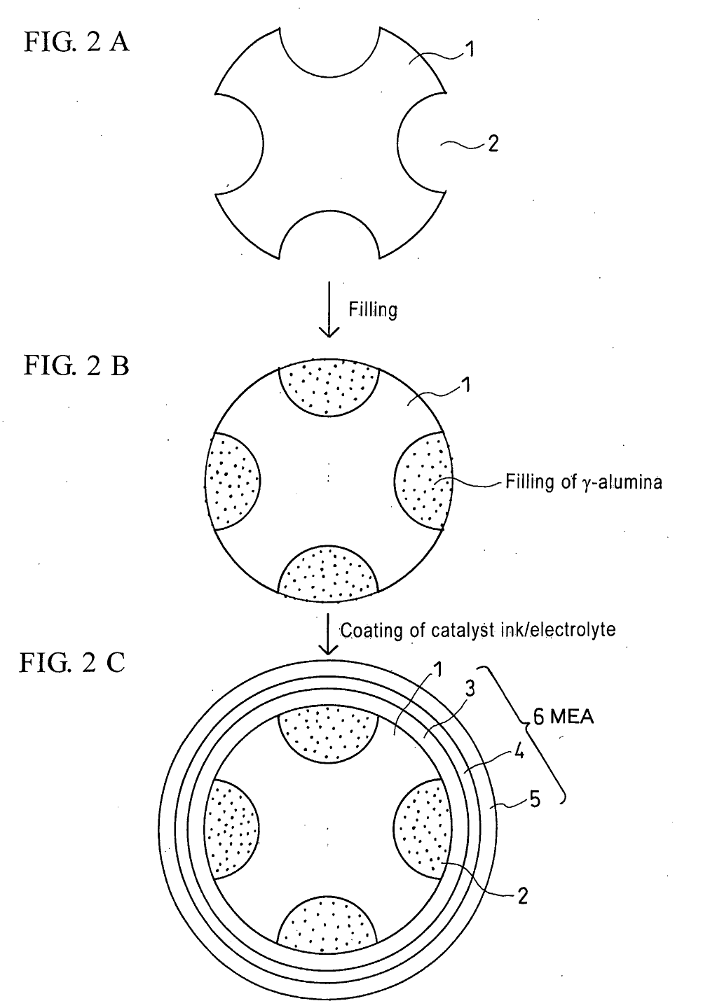

FIGS. 2A-2C show schematic sectional views illustrating an outline of the production steps of the tubular solid polymer fuel cell of the present invention. On the periphery of the rod-shaped current collector 1, there is formed the fuel gas flow channel 2 communicatively continuous in the axial direction of the rod-shaped current collector 1 (FIG. 2A). A part or the whole of the fuel gas flow channel 2 (the whole in FIG. 2A-2C) of the rod-shaped current collector 1, including the fuel gas flow channel 2, is filled with γ-alumina that is a porous material having continuous holes communicatively continuous in the axial direction of the fuel gas flow channel (FIG. 2B). Then, outside the rod-shaped current collector 1 and the fuel gas flow channel 2, there is disposed, in a tubular form, a membrane-electrode assembly (MEA) 6 formed of an electrode catalyst layer 3, a polymer electrolyte membrane 4 and another electrode catalyst layer 5, and thus a tubular solid polymer fuel cell is fabricated.

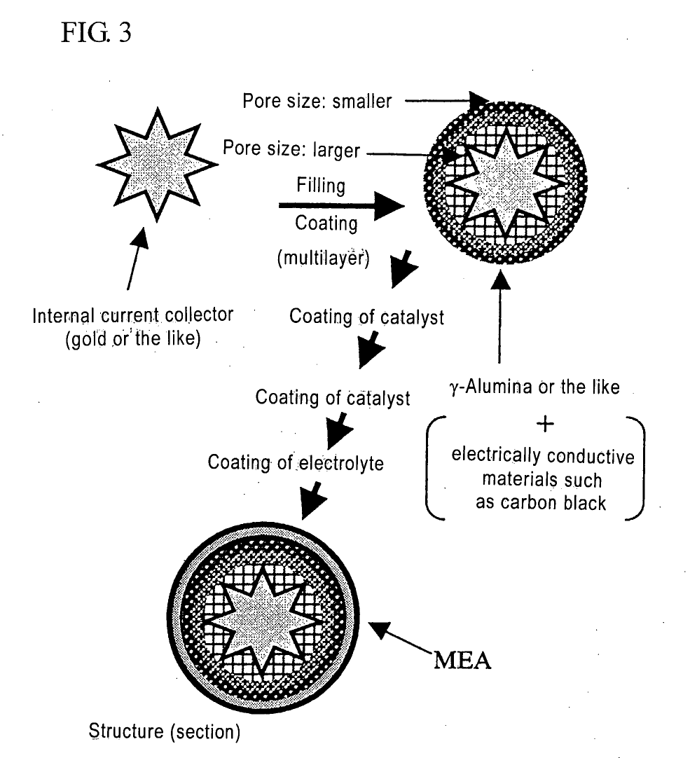

FIG. 3 shows schematic sectional views illustrating an outline of the production steps of the tubular solid polymer fuel cell of the present invention in which fuel cell a porous material is imparted with a gradient structure in which the pore size is increased from the periphery of a rod-shaped current collector toward an internal current collector. Fundamentally, the production steps in FIG. 3 are the same as the production steps of the tubular solid polymer fuel cell shown in FIGS. 2A-2C.

(1) The structure is such that the gas flow channel of the internal current collector is filled with a pore-containing ceramic material, preferably γ-alumina.

(2) The ceramic material in (1) is imparted with a gradient layer structure in which the pore size is smaller on the catalyst layer side and larger on the internal current collector side. Here, the gradient layer structure has at least two layers, but may also have a structure in which the pore size is gradually increased.

(3) The structure is preferably such that fine particles having corrosion resistance and electrical conductivity such as fine particles of carbon black, gold or platinum are beforehand mixed in the ceramic material in (1).

Owing to above (1), when a catalyst paste is coated to form a catalyst layer to be a first layer at the time of fabricating the MEA, the paste does not penetrate into the pores, and hence the diffusion of the gas into the catalyst layer is not inhibited at the time of electric power generation to improve the performance. Additionally, the solid material filled in the flow channel need not be removed after the fabrication of the MEA, and hence the productivity is improved.

Owing to above (2), by making the pore size larger in the portion (the internal current collector side) that does not contribute to the prevention of the penetration of the paste, the performance as well as the gas diffusivity is thereby improved. Additionally, the water drainage is improved, the blocking of the gas flow channel due to water is prevented to promote the gas diffusion, and the performance is improved.

Owing to above (3), the ceramic material can be imparted with electrical conductivity, and hence the cell resistance at the time of the electric power generation of the fuel cell can be reduced.

### EXAMPLES

Next, more detailed description will be made with reference to Examples, Comparative Examples and the accompanying drawings of the present invention.

### Comparative Example 1

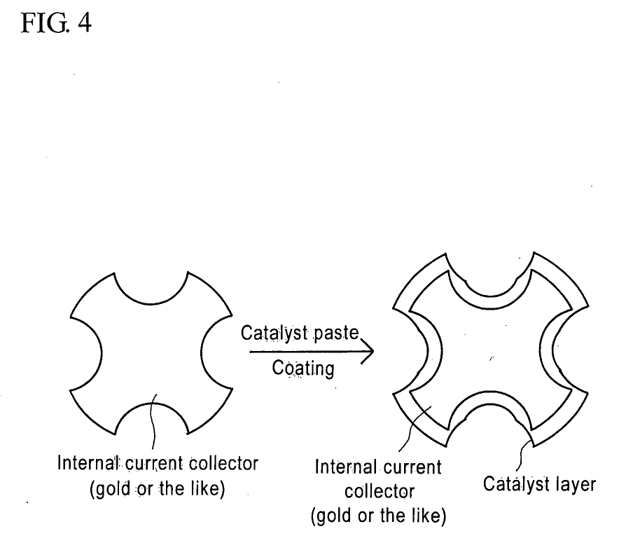

As shown in FIG. 4, in a tubular fuel cell, an internal current collector contributes to the compatibility between the electrical conductivity and the gas diffusivity, and also serves as a substrate at the time of fabricating a MEA. Accordingly, when a catalyst paste is directly coated onto the internal current collector, the paste covers a gas flow channel, and consequently, there has occurred a problem such that after the MEA has been fabricated, the gas does not satisfactorily diffuse into the catalyst layer or the gas flow channel is blocked at the time of electric power generation.

### Comparative Example 2

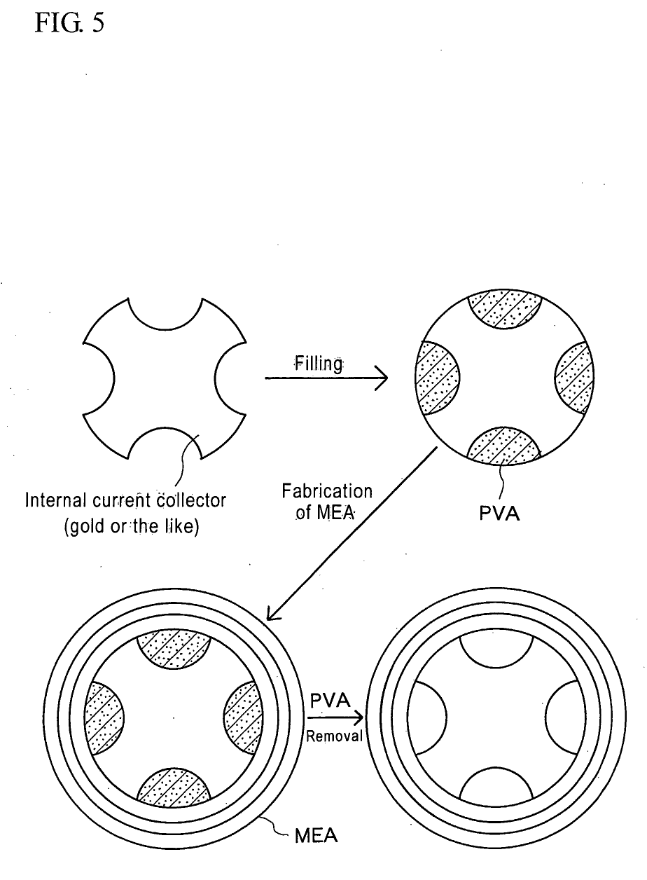

As shown in FIG. 5, conventionally, the gas flow channel is beforehand filled with a resin such as polyvinyl alcohol (PVA), and after a MEA has been fabricated, the PVA is dissolved away with a solvent such as water to ensure a gas flow channel for electric power generation, because PVA is a water-soluble resin. However, it is difficult to identify whether or not the PVA has been completely removed, unless the MEA is broken. Thus, an additional step for removing PVA is required to degrade the productivity.

### Example 1

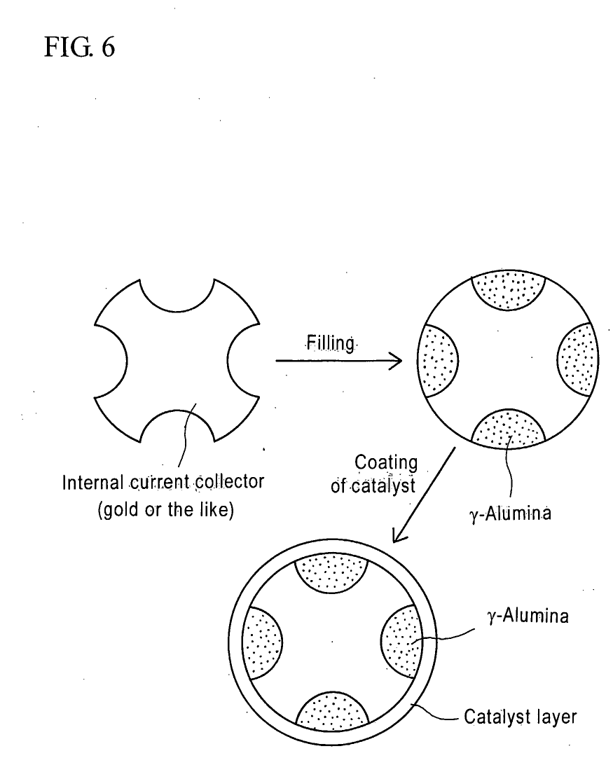

FIG. 6 shows a structure in which γ-alumina is filled in slits as the gas flow channel of an internal current collector in a tubular fuel cell and a method for fabricating the structure. In the present invention, for the purpose of ensuring the gas flow channel of the internal current collector, pore-containing γ-alumina was filled in this flow channel, and thus there was attained a structure in which the penetration of a catalyst paste at the time of fabricating a MEA was prevented, the step for removing the γ-alumina after fabricating the MEA was not needed, and the gas diffusivity at the time of electric power generation was ensured.

Specifically, a solution of γ-alumina prepared by a general preparation method was coated onto the gas flow channel of the internal current collector by the dip coat method. The pore size of the pores in the γ-alumina is 1 nm to 100 nm, preferably 10 nm to 40 nm, and the porosity of the γ-alumina is 40% to 90%, preferably 70% to 90%. Because the secondary particle size of the particles in a catalyst paste in which the catalyst is platinum-supporting carbon is known to be 100 nm or more, such a pore size of γ-alumina as described above can prevent the penetration of the catalyst.

### Example 2

In Example 1, for the purpose of ensuring the gas flow channel of the internal current collector, a pore-containing ceramic material or the like was filled in the flow channel, and thus there was attained a structure in which the penetration of a catalyst paste at the time of fabricating the MEA was prevented, the step for removing the filling material after fabricating the MEA was not needed, and the gas diffusivity at the time of electric power generation was ensured.

However, in the above described structure as it is, even the portion of the gas flow channel which portion does not contribute to the prevention of the penetration of the catalyst paste is filled with the pore-containing ceramic material or the like, and hence the gas diffusivity is ensured insufficiently, and the water drainage is also unsatisfactory. Thus, there is a fear that the gas diffusivity will be inhibited to degrade the performance.

Accordingly, in present Example 2, by making larger the pore size in the portion (the internal current collector side) of the ceramic material filled in the gas flow channel which portion did not contribute to the prevention of the penetration of the catalyst paste, the gas diffusivity and the water drainage were improved to thereby improve the performance.

Specifically, as shown in FIG. 3, ceramic materials having different pore sizes were sequentially coated on the internal current collector by the dip coat method (other methods such as the spray method may also be used) to impart a multilayer structure in which the pore size was increased from outside toward inside. For the purpose of preventing the penetration of the catalyst paste (100 nm or more in particle size), the outermost layer was formed with a ceramic material in which the pore size was 1 to 100 nm, preferably 10 to 40 nm and the porosity was 40 to 90%, preferably 70 to 90%. For the purpose of ensuring the gas diffusivity and the water drainage, the innermost layer was formed with a ceramic material in which the pore size was 100 nm to 50 μm, preferably 10 to 50 μm and the porosity was 40 to 90%, preferably 70 to 90%.

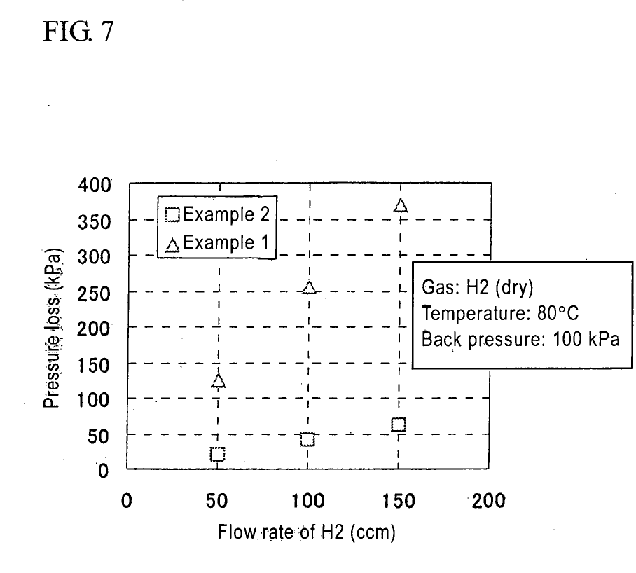

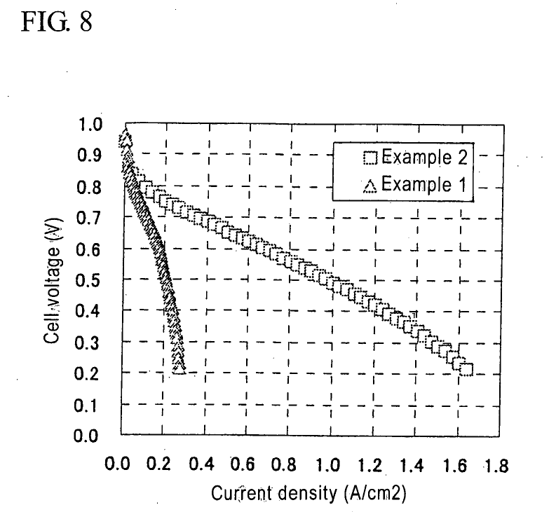

FIG. 7 shows the pressure loss of the gas inside each of the cells in each of which the MEA was formed by the dip coat method on the inner current collector fabricated as described above; the relevant conditions were set as follows: gas: H₂ (dry), temperature: 80° C., back pressure: 100 kPa, and cell length: 20 mm. FIG. 8 shows the electric power generation performance (I-V curves); the relevant conditions were set as follows: outer cathode (air): 100 ccm, bubbler temperature: 80° C., inner anode (H₂): 50 ccm, bubbler temperature: 80° C., back pressure: 100 kPa and cell temperature: 80° C.

As can be seen from FIG. 7, present Example 2 is lower in pressure loss and drastically improved in gas diffusivity as compared to Example 1. As can also be seen from FIG. 8, present Example 2 drastically improves the electric power generation performance as compared to Example 1. These advantageous effects are conceivably ascribable to the reduction of the concentration overvoltage due to the improvement of the gas diffusivity.

### INDUSTRIAL APPLICABILITY

According to the present invention, in the tubular solid polymer fuel cell, the fuel gas smoothly passes through the porous material filled in a part or the whole of the fuel gas flow channel, the catalyst ink does not penetrate into the gas flow channel and does not block the flow channel at the time of fabricating the catalyst layer, and hence the electric power generation performance as well as the gas flow property is thereby improved. In particular, when the porous material is imparted with a gradient structure in which the pore size is increased from the periphery of the rod-shaped current collector toward the internal current collector, such a gradient structure improves the gas diffusivity and water drainage, and hence further improves the electric power generation performance. Accordingly, the present invention contributes to the practical application and the wide spread use of the fuel cell.

1. A tubular solid polymer fuel cell comprising a fuel gas flow channel, on the periphery of a rod-shaped current collector, communicatively continuous in the axial direction of the rod-shaped current collector, further comprising a membrane-electrode assembly (MEA) outside the rod-shaped current collector and the fuel gas flow channel, and having a structure in which fuel gas flows in the fuel gas flow channel and an oxidizing gas flows outside the membrane-electrode assembly (MEA), the tubular solid polymer fuel cell being characterized in that a part or the whole of the fuel gas flow channel is filled with a porous material having continuous holes communicatively continuous in the axial direction of the fuel gas flow channel.

2. The tubular solid polymer fuel cell according to claim 1, characterized in that the fuel gas flow channel comprises one or more slits disposed on the periphery of the rod-shaped current collector so as to be communicatively continuous in the axial direction of the rod-shaped current collector.

3. The tubular solid polymer fuel cell according to claim 1 or 2, characterized in that the porous material is imparted with a gradient structure in which the pore size is increased from the periphery of the rod-shaped current collector toward an internal current collector.

4. The tubular solid polymer fuel cell according to any one of claims 1 to 3, characterized in that the porous material is γ-alumina.

5. The tubular solid polymer fuel cell according to any one of claims 1 to 4, characterized in that the pore size of the pores in the porous material is 1 nm to 100 nm and the porosity of the porous material is 40 to 90%.

6. The tubular solid polymer fuel cell according to any one of claims 1 to 5, characterized in that fine particles having corrosion resistance and electrical conductivity are mixed in the porous material.

7. The tubular solid polymer fuel cell according to any one of claims 1 to 6, characterized in that the rod-shaped current collector is formed of a metal material or a carbon material.

8. A production method of a tubular solid polymer fuel cell, comprising steps of:
forming a fuel gas flow channel on the periphery of a rod-shaped current collector, communicatively continuous in the axial direction of the rod-shaped current collector;
filling a part or the whole of the fuel gas flow channel of the rod-shaped current collector comprising the fuel gas flow channel with a porous material having continuous holes communicatively continuous in the axial direction of the fuel gas flow channel; and
fabricating a membrane-electrode assembly (MEA) outside the rod-shaped current collector and the fuel gas flow channel.

9. The production method of a tubular solid polymer fuel cell according to claim 8, characterized in that the step for forming the fuel gas flow channel forms one or more slits disposed on the periphery of the rod-shaped current collector so as to be communicatively continuous in the axial direction of the rod-shaped current collector.

10. The production method of a tubular solid polymer fuel cell according to claim 8 or 9, characterized in that the porous material is imparted with a gradient structure in which the pore size is increased from the periphery of the rod-shaped current collector toward the internal current collector.

11. The production method of a tubular solid polymer fuel cell according to any one of claims 8 to 10, characterized in that the step for filling the porous material coats a γ-alumina paste onto or fills a γ-alumina paste in the fuel gas flow channel and carries out firing.

12. The production method of a tubular solid polymer fuel cell according to any one of claims 8 to 11, characterized in that the pore size of the pores in the porous material is 1 nm to 100 nm and the porosity of the porous material is 40 to 90%.

13. The production method of a tubular solid polymer fuel cell according to any one of claims 8 to 12, characterized in that fine particles having corrosion resistance and electrical conductivity are beforehand mixed in the porous material.

14. The production method of a tubular solid polymer fuel cell according to any one of claims 8 to 13, characterized in that the rod-shaped current collector is formed of a metal material or a carbon material.

15. The production method of a tubular solid polymer fuel cell according to any one of claims 8 to 14, characterized in that the secondary particle size of the particles in a catalyst paste to be used in the step for fabricating the membrane-electrode assembly (MEA) is 100 nm or more.

16. A transportable electric/electronic device, comprising as an electric power supply the tubular solid polymer fuel cell according to any one of claims 1 to 7.
